(19) United States
(12) Patent Application Publication
(10) Pub. No.: US 2020/0269435 A1
(43) Pub. Date: Aug. 27, 2020

(54) CUTTER REPLACEMENT ROBOT AND ITS ADAPTIVE CUTTER SYSTEM FOR TUNNEL BORING MACHINE

(71) Applicant: DALIAN UNIVERSITY OF TECHNOLOGY, Dalian City, Liaoning Province (CN)

(72) Inventors: Junzhou HUO, Dalian City, Liaoning Province (CN); Zhichao MENG, Dalian City, Liaoning Province (CN); Xiaotong LI, Dalian City, Liaoning Province (CN)

(21) Appl. No.: 16/606,675

(22) PCT Filed: Jan. 12, 2019
(86) PCT No.: PCT/CN2019/071499

§ 371 Date: Oct. 18, 2019

(30) Foreign Application Priority Data
Nov. 8, 2018 (CN) 201811325140.0
Nov. 8, 2018 (CN) 201811325415.0
Dec. 17, 2018 (CN) 201811538565.X
Dec. 17, 2018 (CN) 201811539948.9

(51) Int. Cl. B25J 11/00; B25J 17/02; B25J 18/02; B25J 15/00

(52) U.S. Cl. CPC B25J 11/0055; B25J 17/025; E21C 25/18; B25J 17/0258; B25J 15/0023; B25J 18/02

(57) ABSTRACT

The present invention relates to a cutter replacement robot and its adaptive cutter system for tunnel boring machine and belongs to the field of tunnel construction equipment design. Traditional cutter system adopts multi-wedge fastening mode, and the fasteners are many and separate from each other. It is only suitable for manual disassembly and assembly. So, robot can not disassemble and assemble cutter quickly. For the current cutter weight, the current load-weight ratio of industrial robots can not meet the narrow space inside the cutter head of the TBM, so mature industrial robots can not change the all of cutters. Based on the above situation, according to the internal space structure of the cutter head of the TBM, the invention designs a new type of cutter-changing robot and three type cutter systems to realize the rapid disassembly and assembly of the cutter.

### TECHNICAL FIELD

The present invention relates to a cutter replacement robot comprising a body and an end-effector for a tunnel boring machine (TBM), and a quick-exchanging cutter system adapted to the end-effector. The invention belongs to the technical field of tunnel construction equipment design.

### BACKGROUND

During the construction of the TBM, the cutter consumption is large and the replacement is frequent. The cutter replacement operation time accounts for more than 10% of the tunnel construction period. The existing cutter replacement mainly relies on manual work. So, there are large hidden dangers in the construction environment such as large depth of burial and high water pressure. According to statistics, nearly 70% of tunnel construction safety accidents in China are directly related to manual cutter-changing operations. The international industry problem of “cutter change insurance” has become a bottleneck restricting tunnel construction safety under complex geological conditions. At the same time, with the development of the country, the demand for tunnels is increasing. It was estimated that by 2022, the total length of tunnels such as subways, highways and railways in China will exceed 10,000 kilometers. The automation of some TBM key operating systems is low, which is reflected in the fact that the cutter replacement in the cutter head system is still manual, and not to mention automation and intellectualization. Especially, in extremely harsh working environment (crossing the river, high water and soil pressure (0.77 MPa), high quartz content (60%), high strength pebble (260 MPa), shallow overburden soil (9.8 m), strong weathered rock strata), the automatic cutter replacement technology of composite super-large slurry shield machine needs to be broken through urgently. In case of the above-mentioned poor construction conditions, it takes about 2 hours to replace a cutter under high pressure, and the total time of cutters change is at least one-third of the entire construction period. In summary, reducing safety risks, improving construction progress, reducing construction costs, and ultimately realizing “replacement of cutters by Machine” are the urgent problems to be solved in the field of tunnel construction.

Traditional cutter system adopts multi-wedge fastening mode, and the fasteners are many and separate from each other. It is only suitable for manual disassembly and assembly. For the current cutter, the current load-weight ratio of industrial robots can not meet the narrow space inside the cutter head of the TBM, so mature industrial robots can not exchange the all of cutter.

Based on the above situation, according to the internal space structure of the cutter head of the TBM, the invention designs a new type of cutter replacement robot and its adaptive cutter system for TBM to realize the rapid disassembly and assembly of the TBM cutters.

### SUMMARY

The invention aims to overcome the difficulty in working in the joint space where the horizontal narrow space of the full-face tunneling machine is suddenly changed into a vertical narrow space, and designs a cutter-changing robot mechanism scheme on the TBM. At the same time, three new tunneling boring machine cutter systems are designed to facilitate quick disassembly and assembly of the cutter replacement robot. If these three new cutter systems and the cutter-changing robot are applied to the cutter-changing operation, which reduces the safety risk of the cutter changer and improves the cutter-changing efficiency.

### Technical Solution of the Invention

A TBM cutter replacement robot and its adaptive cutter system, including the cutter replacement robot mechanism scheme, three new TBM cutter systems and the motion analysis of the TBM cutter replacement robot;

I. The Mechanism of the Cutter Replacement Robot

The cutter replacement robot is mainly composed of two parts: a body of the cutter replacement robot 1-1 and an end-effector of the cutter replacement robot 1-2. The body of the cutter replacement robot 1-1 is responsible for adjusting the position of the cutter center point and receiving the weight the external load of the end-effector and. The end-effector of the cutter replacement robot 1-2 is responsible for adjusting its posture and disassembling and assembling the cutter. As shown in FIG. 1.

II. Three New TBM Cutter Systems

In order to realize the rapid disassembly and assembly of the TBM cutter, three new cutter systems are designed. The fasteners of the new cutter system are integrated to simplify the cutter change action and improve the cutter change efficiency.

III. Motion Analysis of Cutter Replacement Robot for TBM

Aiming at the joint working space of the full-face tunneling machine from the horizontal narrow space to the vertical narrow space, the polar-type TBM cutter replacement robot was designed. The working range of the cutter replacement robot was adapted to the internal space of the TBM. The kinematics analysis is shown in FIG. 30.

### Beneficial Effects of the Invention

The present invention firstly designs three new TBM cutter systems in combination with the current robot cutters. The cutter fasteners are integrated, so the cutter changing action is simplified. At the same time, combined with the disassembly interface of the cutter systems, a robot body and end-effector structure suitable for the cutter change working space of the TBM is designed. Through kinematics analysis, the cutter replacement robot can achieve accurate disassembly and assembly of all of cutters. The aim is to reduce the safety risk of manual cutter-changing, improve the construction efficiency of tunneling equipment, solve the problem of tunnel engineering cutter change and low cutter change efficiency.

### DESCRIPTION OF DRAWINGS

FIG. 1 is an overall schematic diagram of the cutter replacement robot of TBM;

FIG. 2 is a schematic diagram of the body structure of TBM cutter replacement robot;

FIG. 3 is a schematic diagram of the scissor lift structure of TBM cutter replacement robot;

FIG. 4 is a schematic diagram of the big arm and sliding base of TBM cutter replacement robot;

FIG. 5 is a schematic diagram of the end-effector of TBM cutter replacement robot;

FIG. 6 is a schematic diagram of the cutter grasping device and tightening screw device of end-effector of TBM cutter replacement robot;

FIG. 7 is a schematic diagram of the gear drive device of end-effector of TBM cutter replacement robot;

FIG. 8 is a schematic diagram of the bolt tightening device of end-effector of TBM cutter replacement robot;

FIG. 9 is a schematic diagram of the position and attitude adjustment device of end-effector of TBM cutter replacement robot;

FIG. 10 is a schematic diagram of the telescopic and mobile device of end-effector of TBM cutter replacement robot;

FIG. 11 is an overall schematic diagram of the scheme 1 of cutter system of TBM;

FIG. 12 is a schematic diagram of the integrated cutter system of cutter system scheme 1 of TBM;

FIG. 13 is a schematic diagram of the clamping mechanism of cutter system scheme 1 of TBM;

FIG. 14 is a schematic diagram of the cutter box of cutter system scheme 1 of TBM;

FIG. 15 is a schematic diagram of the cutter installation of cutter system scheme 1 of TBM;

FIG. 16 is a schematic diagram of the clamping state of cutter system scheme 1 of TBM;

FIG. 17 is an overall schematic diagram of the scheme 2 of cutter system of TBM;

FIG. 18 is a schematic diagram of the integrated cutter system of cutter system scheme 2 of TBM;

FIG. 19 is a schematic diagram of the cutter box side panel of cutter system scheme 2 of TBM;

FIG. 20 is a schematic diagram of the cutter clamping mechanism of cutter system scheme 2 of TBM;

FIG. 21 is a schematic diagram of the lifting and shifting device of cutter system scheme 2 of TBM;

FIG. 22 is a schematic matching diagram of the rotating carrier and dial block of cutter system scheme 2 of TBM;

FIG. 23 is a schematic diagram of the cutter installation of cutter system scheme 2 of TBM;

FIG. 24 is a schematic diagram of the cutter packed into box of cutter system scheme 2 of TBM;

FIG. 25 is a schematic diagram of the clamping state of cutter system scheme 2 of TBM;

FIG. 26 is the overall schematic diagram of the scheme 3 of cutter system of TBM;

FIG. 27 is a schematic diagram of the cutter box of cutter system scheme 3 of TBM;

FIG. 28 is a schematic diagram of the integrated cutter system of cutter system scheme 3 of TBM;

FIG. 29 is a schematic diagram of the cutter installation and clamping state of cutter system scheme 3 of TBM;

FIG. 30 is a kinematic analysis diagram of the cutter replacement robot of TBM;

FIG. 31 is an initial state diagram of the cutter replacement robot of TBM;

FIG. 32 is a schematic diagram of exit door of the cutter replacement robot of TBM;

FIG. 33 is a schematic diagram of adjusting the end-effector when the cutter replacement robot of TBM;

FIG. 34 is a schematic diagram of cutter grasping by the cutter replacement robot of TBM;

FIG. 35 is a detail diagram of cutter grasping by end-effector the cutter replacement robot of TBM;

FIG. 36 is a schematic diagram of contraction of each joint of the cutter replacement robot of TBM;

FIG. 37 is a schematic diagram of the cutter replacement robot of TBM returning to its initial state;

wherein: 1-1: Body of the cutter replacement robot; 1-2: End-effector of the cutter replacement robot; 2-1: Main body of the scissor lift; 2-2 Guide rail; 2-3: Slide block of guide rail; 2-4: The big arm of the robot; 2-5: Sliding base of the robot; 2-6: Fixed base of the robot; 3-1: Movable board of lift; 3-2: Shearing mechanism; 3-3: Upper ball screw; 3-4: Driving gear of the shearing mechanism; 3-5: Driven gear of the shearing mechanism; 3-6: Hydraulic motor; 3-7: Substrate of the scissor lift; 3-8: Central connection ring; 3-9: Bending plate; 3-10: Lower ball screw; 4-1: Swing hydraulic motor; 4-2: Telescopic arm of the robot; 4-3: Base arm of the robot; 4-4: Single-rod double-acting hydraulic cylinder; 4-5: Robot arm support leg; 4-6: Robot slipper; 5-1: Substrate of the end actuator; 5-2: Cutter grab device; 5-3: Screw bolts device; 5-4: Attitude adjustment device; 5-5: Telescopic device; 6-1: Hydraulic cylinder for driving claw; 6-2: Connection joint between claw and hydraulic cylinder; 6-3: Claw movable part; 6-4: Claw fixing part; 6-5: Connecting flange between claw and reducer; 6-6: Reducer housing cover; 6-7: Reducer housing; 6-8: Reducer; 6-9: Reducer mounting plate; 6-10: Hydraulic motor; 7-1: Reducer large gear installation plate; 7-2: Large gear of the reducer; 7-3: Reducer pinion; 8-1: Inner hexagonal sleeve; 8-2: Cross-shaft universal coupling; 8-3: Transmission shaft; 9-1: Steering hydraulic cylinder support hinge; 9-2: Steering hydraulic cylinder; 9-3: hydraulic cylinder joint; 10-1: Linear guide rail; 10-2: Telescopic hydraulic cylinder; 10-3: Reducer support; 10-4: Telescopic hydraulic cylinder outlet joint; 10-5: Reducer support mounting seat; 10-6: Reducer support slipper; 11-1: Cutter clamping mechanism; 11-2: Cutter box; 11-3: Cutter of Scheme 1; 11-4: Cutter gripper; 12-1: Screw; 12-2: Axle sleeve; 12-3: Shifting fork; 12-4: Clamping block; 12-5: Clamping block slider; 12-6: Cutter fixed frame; 12-7: Pin shaft; 12-8: Tapered roller bearing; 12-9: Spin axis clamping block and shifting fork; 13-1: Cutter box welding section; 13-2: Cutter box side panel; 13-3: Slot matched with clamping block; 14-1: Cutter box; 14-2: Cutter of scheme 2; 14-3: Cutter fixed frame; 14-4: Clamping device; 14-5: Lifting and shifting device; 14-6 Cutter gripper; 15-1: Slot matched with clamping block; 16-1: Clamping block support plate; 16-2: Clamping block rotating shaft; 16-3: Protective plate; 16-4: Dial block; 16-5: Clamping block; 17-1: Guide rail; 17-2: slider of Clamping block; 17-3: Bearing seat; 17-4: screw; 17-5: Nut mounting seat; 17-6: Rotating carrier; 18-1: Cutter box; 18-2: Integrated cutter System; 18-3: Cutter of scheme 3; 19-1: Cutter box side panel; 19-2: Cutter box welding section; 20-1: Clamping block; 20-2: Connecting rod; 20-3: Screw; 20-4: Special nut; 20-5: Pre-tightening nut; 20-6: End cover; 20-7: Upper bearing bush; 20-8: Lower bearing bush; 20-9: cutter mounting plate; 20-10: Cutter gripper; A: Cross section of cutter base; B: Cross section of gripper.

### DETAILED DESCRIPTION

Following is a detailed description of the specific implementation of the invention in connection with the drawings and technical solutions. And the new cutter system is exemplified by Solution 1.

A cutter replacement robot for the TBM and its corresponding cutter system are presented, including three parts—the mechanism scheme of cutter replacement robot, three new cutter systems for the TBM and the motion analysis of the cutter replacement robot.

I. Mechanism of the Cutter Replacement Robot

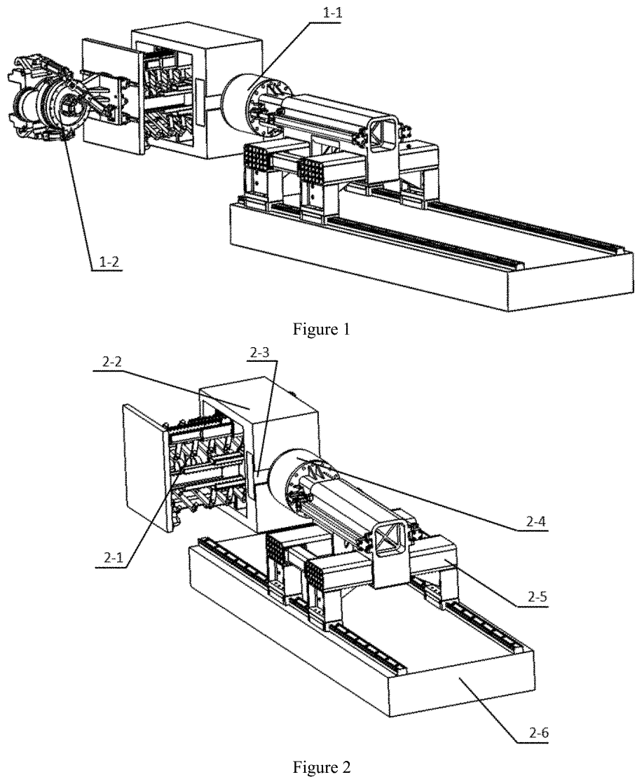

The cutter replacement robot is mainly composed of two parts—a body of the cutter replacement robot 1-1 and an end-effector of the cutter replacement robot 1-2. The body of the cutter replacement robot 1-1 is responsible for adjusting the position of the cutter center point and accepting the weight and load of the end-effector. And the cutter-changing robot end-effector 1-2 is responsible for adjusting its attitude and disassembling and assembling the cutter. As shown in FIG. 1.

(1) Body of the Cutter Replacement Robot

The body of the cutter replacement robot of the TBM is mainly composed of main body of the scissor lift 2-1, guide rail 2-2, slide block of guide rail 2-3, big arm of the robot 2-4, sliding base of the robot 2-5 and fixed base of the robot 2-6. The fixed base of the robot 2-6 and sliding base of the robot 2-5 constitute first mobile joint of the robot, and the big arm of the robot 2-4 and the sliding base of the robot 2-5 constitute second mobile joint of the robot. These two mobile joints constitute first degree of freedom of the cutter replacement robot. Slide block of guide rail 2-3 and the big arm of the robot 2-4 constitute third joint (rotating pair) which is second degree of freedom of the cutter replacement robot. The guide rail 2-2 and slide block of guide rail 2-3 constitute fourth joint (mobile pair) of the robot. The main body of the scissor lift 2-1 and the guide rail 2-2 constitute the fifth joint (mobile pair) of the cutter replacement robot. The fourth joint and the fifth joint constitute third degree of freedom of the cutter replacement robot. As shown in FIG. 2.

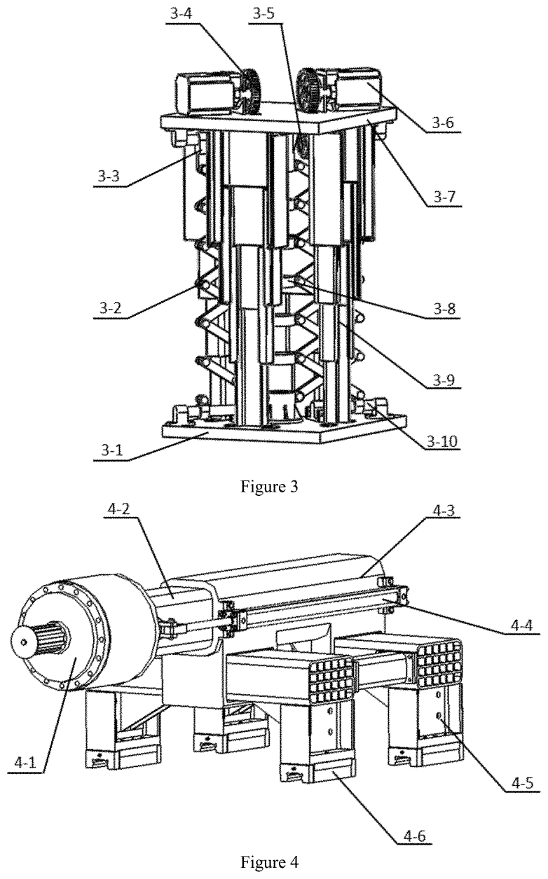

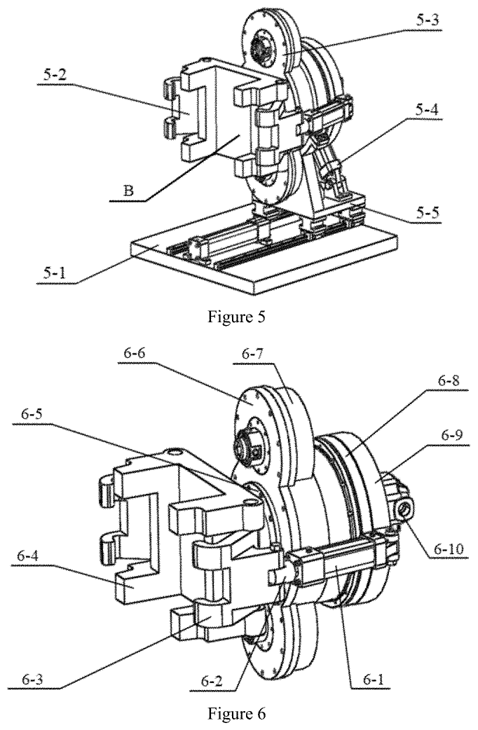

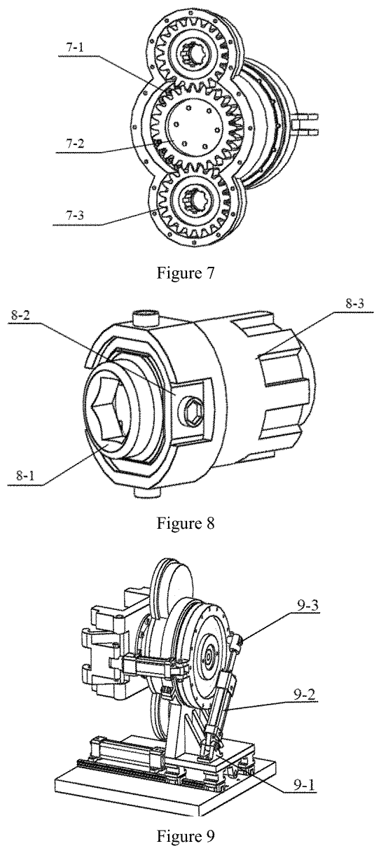

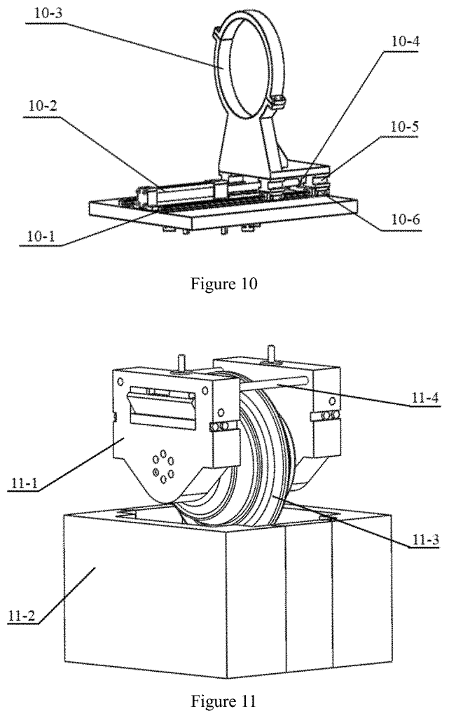

The main body of the scissor lift 2-1 includes movable board of lift 3-1, shear mechanism 3-2, upper ball screw 3-3, driving gear of the shearing mechanism 3-4, driven gear of the shearing mechanism 3-5, hydraulic motor 3-6, substrate of the scissor lift 3-7, central connection ring 3-8, bending plate 3-9 and lower ball screw 3-10. The hydraulic motor 3-6 is installed on the upper surface of the substrate of the scissor lift 3-7. The driving gear of the shearing mechanism 3-4 is directly fixed on the output shaft of the hydraulic motor 3-6. The driven gear of the shearing mechanism 3-5 is installed on the lower surface of the substrate of the scissor lift 3-7 and meshes with the driving gear of the shearing mechanism 3-4. One end of the upper ball screw 3-3 is fixed on the lower surface of the substrate of the scissor lift 3-7, and the other end is connected to the shaft hole of the driven gear of the shearing mechanism 3-5. The upper end rod of the shear mechanism 3-2 is connected with the nut sleeve of the upper ball screw 3-3. The lower end rod of the shearing mechanism 3-2 is connected with the nut sleeve of the lower ball screw 3-10. The lower ball screw 3-10 is installed on the upper surface of the movable board of lift 3-1. The four sets of bending plate 3-9 are composed of four bending plates in series. The upper end of bending plate 3-9 is connected to the lower surface of the substrate of the scissor lift 3-7, and the lower end is connected to the upper surface of the movable board of lift 3-1. The end-effector is fixed on the lower surface of the movable board of lift 3-1. The main body of the scissor lift of the cutter replacement robot is shown in FIG. 3.

The big arm of the robot 2-4 includes a swing hydraulic motor 4-1, telescopic arm of the robot 4-2 and single-rod double-acting hydraulic cylinder 4-4. The swing hydraulic motor 4-1 is mounted on the telescopic arm of the robot 4-2, and its output shaft is matched with the central hole of slide block of guide rail 2-3. Two single-rod double-acting hydraulic cylinders 4-4 are symmetrically mounted on the left and right sides of the base arm of robot 4-3. As shown in FIG. 4.

The sliding base of the robot 2-5 includes the base arm of the robot 4-3, robot arm support leg 4-5 and robot slipper 4-6. The robot arm support leg 4-5 is mainly composed of two saddle-shaped structural steels connected by two hollow square bars. The robot slipper 4-6 is fixed at the bottom of the robot arm support leg 4-5 through bolts. The robot slipper 4-6 and the fixed base of the robot 2-6 cooperate to realize sliding. The base arm of the robot 4-3 is connected to the saddle-shaped structural steel of the robot arm support leg 4-5. The sketch diagram of the big arm and the sliding base of cutter replacement robot are shown in FIG. 4.

(2) End-Effector of the Cutter Replacement Robot

The end-effector of the cutter replacement robot of the TBM includes substrate of the end actuator 5-1, cutter grab device 5-2, screw bolts device 5-3, attitude adjustment device 5-4 and telescopic device 5-5.

The substrate of the end actuator 5-1 is mainly used for installation and connection, on which threaded holes are connected with linear guide rail 10-1 and telescopic hydraulic cylinder 10-2 through threads to provide the installation carrier for the end-effector.

The cutter grasping device 5-2 includes hydraulic cylinder for driving claw 6-1, connection joint between claw and hydraulic cylinder 6-2, claw movable part 6-3, claw fixing part 6-4 and connecting flange between claw and reducer 6-5. The hydraulic cylinder for driving claw 6-1 provides power for claw movable part 6-3 tension. One end of hydraulic cylinder for driving claw 6-1 is connected with reducer mounting plate 6-9 through hinging. The push rod of the hydraulic cylinder for driving claw 6-1 is connected with connection joint between claw and hydraulic cylinder 6-2 through threads. The connection joint between claw and hydraulic cylinder 6-2 is connected with claw movable part 6-3 through articulation. The claw movable part 6-3 and claw fixing part 6-4 are connected by articulation. The claw fixing part 6-4 is connected with reducer housing cover 6-6 through connecting flange between claw and reducer 6-5 to achieve the fixing of cutter grab device 5-2.

The screw bolts device 5-3 comprises a reducer housing cover 6-6, a reducer housing 6-7, a reducer 6-8, a reducer mounting plate 6-9, a hydraulic motor 6-10, a reducer pinion 7-3, a large gear of the reducer 7-2, a reducer large gear installation plate 7-1, an inner hexagonal sleeve 8-1, cross-shaft universal coupling 8-2 and a transmission shaft 8-3. The hydraulic motor 6-10 provides power for screw, and is fixed with reducer mounting plate 6-9 through threaded connection. The reducer 6-8 makes the power of hydraulic motor 6-10 to reduce speed and increase torsion by connecting threads with the reducer mounting plate 6-9. The reducer large gear installation plate 7-1 connects the reducer 6-8 with the large gear of the reducer 7-2 through screw to realize motion transmission. The reducer housing 6-7 is fixed with the reducer 6-8 through screw, providing installation space for the reducer pinion 7-3, the large gear of the reducer 7-2 and the transmission shaft 8-3. The reducer housing cover 6-6 and the reducer housing 6-7 form a closed space through screw connection, which is convenient for gear protection and lubrication. The inner contour shape of the inner hexagonal sleeve 8-1 is hexagonal, and is connected with the transmission shaft 8-3 through the cross-shaft universal coupling 8-2. The cross-shaft universal coupling 8-2 realizes the pitch and deflection of the inner hexagonal sleeve 8-1. Pitch and deflection of the inner hexagonal sleeve 8-1 are used to compensate position. The transmission shaft 8-3 is used to transfer motion through spline and the reducer pinion 7-3.

The attitude adjustment device 5-4 includes a steering hydraulic cylinder support hinge 9-1, a steering hydraulic cylinder 9-2 and a hydraulic cylinder joint 9-3. The steering hydraulic cylinder support hinge 9-1 is mounted on the base of the reducer support 10-3 by screws to provide a mounting base for the steering hydraulic cylinder 9-2. The steering hydraulic cylinder 9-2 provides power for the adjustment action of the end-effector. The steering hydraulic cylinder 9-2 is articulated with the steering hydraulic cylinder support hinge 9-1, and push rod of the steering hydraulic cylinder 9-2 is connected to the hydraulic cylinder joint 9-3 through the thread. The hydraulic cylinder joint 9-3 is connected with the reducer mounting plate 6-9 through the pin shaft, and drives the cutter grab device 5-2 and the screw bolts device 5-3 to rotate the shaft to realize the fine tuning of the end-effector.

The telescopic device 5-5 comprises a linear guide rail 10-1, a telescopic hydraulic cylinder 10-2, a reducer support 10-3, a telescopic hydraulic cylinder outlet joint 10-4, a reducer support mounting seat 10-5 and a reducer support slipper 10-6. The linear guide rail 10-1 is fixed on the substrate of the end actuator 5-1 by screw. The reducer support slipper 10-6 is matched with the linear guide rail 10-1 to realize load-bearing and guidance. The telescopic hydraulic cylinder 10-2 provides power for the telescopic motion of end-effector. The cylinder block of the telescopic hydraulic cylinder 10-2 is fixed on the substrate of the end actuator 5-1 by screw. The push rod of the telescopic hydraulic cylinder 10-2 is connected with the telescopic hydraulic cylinder outlet joint 10-4 through the thread. The bottom of reducer support 10-3 is connected with the reducer support slipper 10-6 through the reducer support mounting seat 10-5. The upper part of the reducer support 10-3 and the reducer housing 6-7 form a rotating pair. The telescopic hydraulic cylinder outlet joint 10-4 is fixed on the lower surface of the reducer support 10-3 by screw, which drives the reducer support 10-3 to move in a straight line and further drives the cutter grab device 5-2, the screw bolts device 5-3 and the attitude adjustment device 5-4 moving in a straight line.

II. Three New TBM Cutter Systems

In order to realize the rapid disassembly and assembly of the TBM cutter replacement robot, three new cutter systems are designed; the fasteners of the new cutter system are integrated, the cutter change action is simplified, and the cutter change efficiency is improved.

(1) New TBM Cutter System Scheme 1

The first integrated full-face rock TBM cutter holder is mainly composed of four components: cutter clamping mechanism 11-1, cutter box 11-2, cutter 11-3 and cutter gripper 11-4, as shown in FIG. 11.

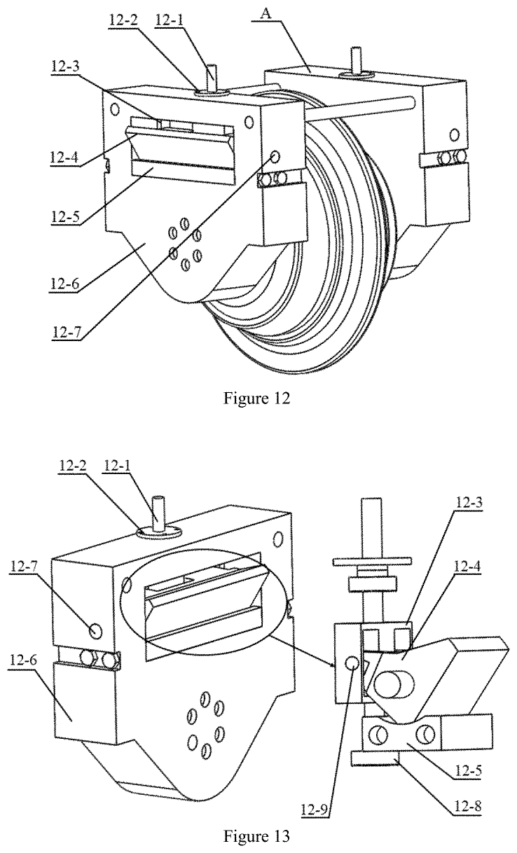

The cutter clamping mechanism 11-1 is mainly composed of screw 12-1, axle sleeve 12-2, shifting fork 12-3, clamping block 12-4, clamping block slider 12-5, cutter fixed frame 12-6, pin shaft 12-7, tapered roller bearing 12-8 and spin axis clamping block and shifting fork 12-9, as shown in FIG. 12. The screw 12-1 has a stepped section. The screw 12-1 can be rotated around itself by two tapered roller bearing 12-8, and the screw 12-1 passes through the threaded hole of the shifting fork 12-3 to drive the shifting fork 12-3 to move up and down. The upper end of the screw 12-1 is axially positioned by the axle sleeve 12-2; the middle of the shifting fork 12-3 is machined with a vertical threaded hole, and the square cavity is machined on both sides. The square cavity of the shifting fork 12-3 matches with the clamping block 12-4, which are connected by two spin axis clamping block and shifting fork 12-9; the clamping block 12-4 is installed in the square groove of the cutter fixed frame 12-6 through the pin shaft 12-7; the clamping block slider 12-5 is fixed on the square groove of the cutter fixed frame 12-6 by four screws. The upper surface of the clamping block slider 12-5 is an arc groove, and the first clamping block 12-4 can slide along the arcuate groove of the clamping block slider 12-5; the cutter shaft of the cutter 11-3 is fixed between the two cutter fixed frame 12-6 by screws.

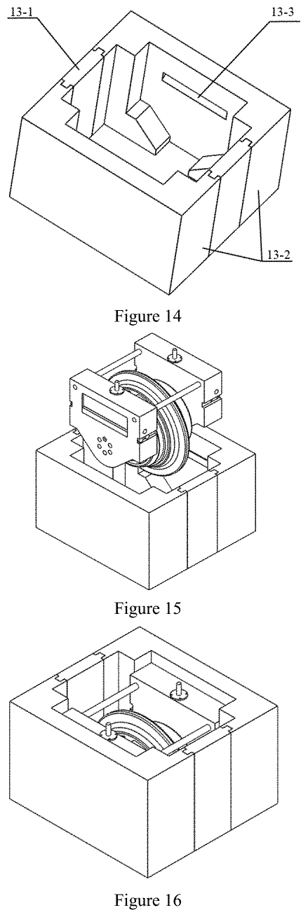

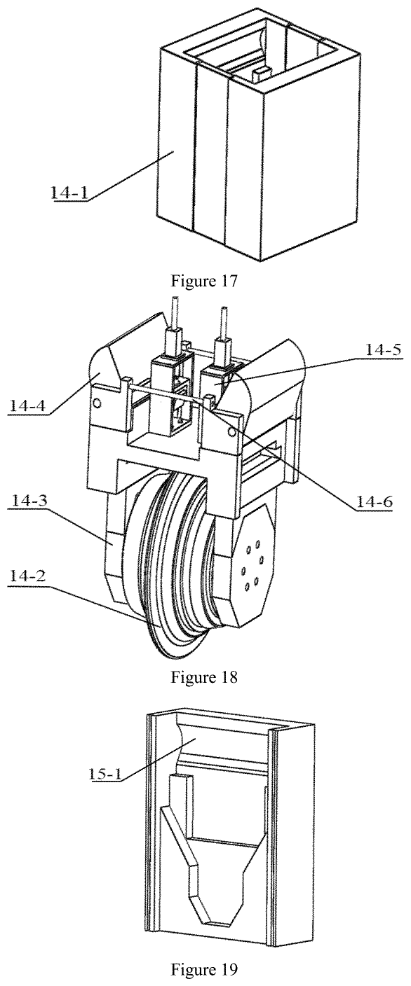

The cutter box 11-2 is mainly composed of two cutter box welding section 13-1 and two cutter box side panel 13-2, as shown in FIG. 14; the cutter box welding section 13-1 reduces the processing difficulty of the cutter box side panel 13-2, and at the same time acts as the function of connection. The inside of the cutter box side panel 13-2 is provided with slot matched with clamping block 13-3 and a profile matching with cutter fixed frame 12-6. The contour of the slot matched with clamping block 13-3 is matched with the card edge profile of the first clamping block 12-4, so that the slot matched with clamping block 13-3 can be well positioned while receiving a large impact load from the cutter. The cutter box 11-2 is welded to the cutter head during the operation of the full-face tunnel boring machine.

The cutter gripper 11-4 is used to connect the two cutter fixed frames 12-6, and at the same time, the robot is convenient to take the cutter out of the cutter box.

Working process: The robot sends the cutter to the front end of the cutter box 11-2 through the cutter gripper 11-4, at which time the first clamping block 12-4 is in a closed state, as shown in FIG. 15. Then, the cutter is sent to the cutter box 11-2, and the first clamping block 12-4 is driven to open by rotating the screw 12-1, so that the first clamping block 12-4 is fastened to the slot matched with clamping block 13-3 of the side panel of the cutter box 11-2, as shown in FIG. 16.

(2) New TBM Cutter System Scheme 2

The second type of TBM cutter system comprises cutter box 14-1, cutter 14-2, cutter fixed frame 14-3, clamping device 14-4, a lifting and lifting and shifting device 14-5 and cutter gripper 14-6, as shown in FIGS. 17 and 18.

The inner structure of the cutter box 14-1 is shown in FIG. 17. The inner surface of the cutter box 14-1 is adapted to the shape of the outer surface of the cutter fixed frame 14-3. The slot matched with clamping block 15-1 is formed inside the cutter box 14-1 to realize a fastening cutter.

The cutter fixed frame 14-3 is connected to the arbor of the cutter of scheme 2 14-2 by screws and fixed to the clamping device 14-4 by screws.

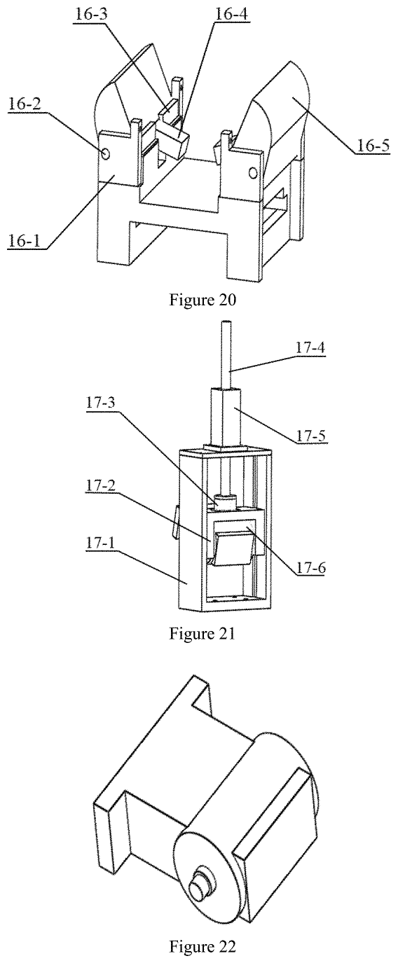

The clamping device 14-4 includes a clamping block support plate 16-1, a clamping block rotating shaft 16-2, a protective plate 16-3, a dial block 16-4, and a clamping block 16-5, as shown in FIG. 20. The clamping block support plate 16-1 is fixed to the upper part of the cutter fixed frame 14-3 by screws, and supports other parts; the clamping block 16-5 constitutes a rotating pair by the connection of the clamping block rotating shaft 16-2 and the clamping block 16-5; the two ends of the clamping block rotating shaft 16-2 are fixed to the clamping block support plate 16-1 by screws, and are used for fixing the clamping block 16-5 on the clamping block support plate 16-1; the dial block 16-4 is welded to the clamping block 16-5, and the clamping blocking movement of the clamping block 16-5 is achieved by dialing the dial block 16-4; the protective plate 16-3 is connected to the upper support frame of the cutter fixed frame 14-3 by screws to prevent dust and gravel from entering, and affects the opening movement of the clamping block 16-5.

The lifting and shifting device 14-5 comprises a guide rail 17-1, a slider of clamping block 17-2, a bearing seat 17-3, a screw 17-4, a nut mounting seat 17-5 and a rotating carrier 17-6, as shown in FIG. 21; the guide rail 17-1 is a square frame structure, and a rail is arranged in the square frame; the guide rail 17-1 is connected to the upper support frame of the cutter fixed frame 14-3 by screws; the shape of the boss on the outer side of the two sides of the slider of clamping block 17-2 is adapted to the groove formed on the clamping block support plate 16-1 to realize a linear motion freedom; the inner side of the two sides of the slider of clamping block 17-2 is provided with a hole, and the bearing is mounted to realize the bearing function; the rotating carrier 17-6 is matched with the slider of clamping block 17-2, as shown in FIG. 22; the nut mounting seat 17-5 is fixed to the upper surface of the guide rail 17-1 by screw connection; the screw 17-4 is matched with the nut mounting seat 17-5 through the thread pair, and the screw 17-4 thread can be self-locking; the screw 17-4 passes through the nut mounting seat 17-5, protrudes into the guide rail 17-1, and is fixed on the slider of clamping block 17-2 through the bearing seat 17-3; by rotating the screw 17-4, the reciprocating linear motion of the slider of clamping block 17-2 along the guide rail 17-1 is realized, and the rotating carrier 17-6 is further driven to rotate the shaft. Thus, the dial block 16-4 is dialed to realize the opening movement of the clamping block 16-5.

The cutter gripper 14-6 is mounted on the clamping block support plate 16-1, the two ends are fixed by screws, and the end-effector realizes the cutter entering and leaving the cutter box 14-1 by grasping the cutter gripper 14-6.

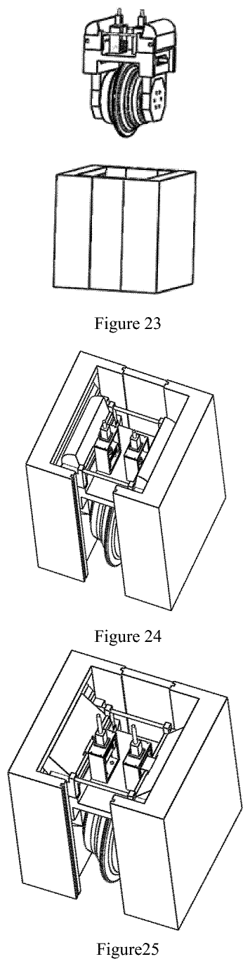

Working process: the robot sends the cutter to the front end of the cutter box 14-1 by clamping the cutter gripper 14-6, and the clamping device 14-4 is in the closed state, as shown in FIG. 23. Then, the cutter is sent into the cutter box 14-1, and the clamping block 16-5 is opened by rotating the screw 17-4, as shown in FIG. 24. The clamping block 16-5 is fastened to the slot matched with clamping block 15-1 of the side panel of the cutter box 14-1, as shown in FIG. 25.

(3) New TBM Cutter System Scheme 3

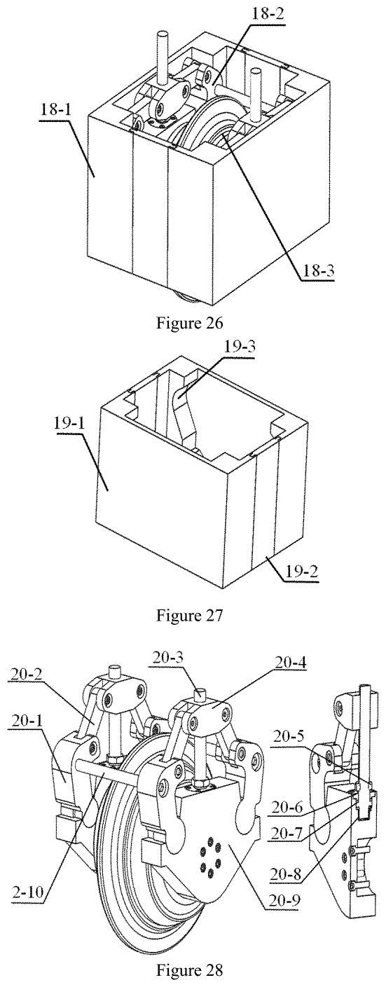

The third TBM cutter system is mainly composed of a cutter box 18-1, an integrated cutter system 18-2 and a cutter 18-3, as shown in FIG. 26.

The cutter box 18-1 is a box mainly composed of two cutter box side panel 19-1 and two cutter box welding section 19-2; the upper half of the left and right sides of the two cutter box side panels 19-1 are respectively provided with the slot matched with clamping blocks 19-3, as shown in FIG. 27.

The integrated cutter system 18-2 is mainly composed of a clamping block 20-1, a connecting rod 20-2, a screw 20-3, a special nut 20-4, a pre-tightening nut 20-5, and an end cover 20-6, upper bearing bush 20-7, lower bearing bush 20-8, cutter mounting plate 20-9 and cutter gripper 20-10, as shown in FIG. 28. The clamping block 20-1 has an open slot at the upper end thereof, and a through hole is formed in the direction of the vertical opening slot. A through hole for connecting the cutter gripper 20-10 is opened on one side of the clamping block 20-1, and the lower end of the clamping block 20-1 is stepped arc cylinder of which the stepped surface is used for positioning and rotates around the arcuate groove on the side panel 20-9 of the cutter. The connecting rod 20-2 is used to connect the clamping block 20-1 and the special nut 20-4, and the movement of the special nut 20-4 is converted into the rotation of the clamping block 20-1 while supporting the clamping block 20-1 to be fitted on the slot matched with clamping block 19-3 of the cutter box; the special nut 20-4 is a nut-like structure with a threaded hole in the center and an open slot at both ends, as shown in FIG. 31. The open slot of the upper end of the clamping block 20-1 and the open slot of the special nut 20-4 are used to realize the connection of the clamping block 20-1, the connecting rod 20-2 and the special nut 20-4; the screw 20-3 passes through the central threaded hole of the special nut 20-4, and further fixes the cutter mounting plate 20-9; the pre-tightening nut 20-5 is set on the screw 20-3, and is located on the upper surface of the cutter side panel 20-9, which moves up and down in synchronization with the special nut 20-4 as the screw 20-3 rotates. They act as a double nut lock. The upper end cap 20-6 is used to fix one end of the screw 20-3 so that it can only rotate around itself and cannot move up and down; the upper bearing bush 20-7 and the lower bearing bush 20-8 limit the diameter of the slide block of guide rail 2-3 move to the side while being easy to replace after wear; the lower contour surface of the cutter mounting plate 20-9 completely fits the side surface of the cutter box side panel 19-1, and functions similarly to the frame for fixing and connecting the accessory parts; the cutter gripper 20-10 is attached to the clamping block 20-1 to facilitate the robot to remove the integrated cutter system 18-2 from the cutter box 18-1. At the same time, the slide block of guide rail 2-3 of the new full-face tunneling machine integrated cutter system needs to be self-locking.

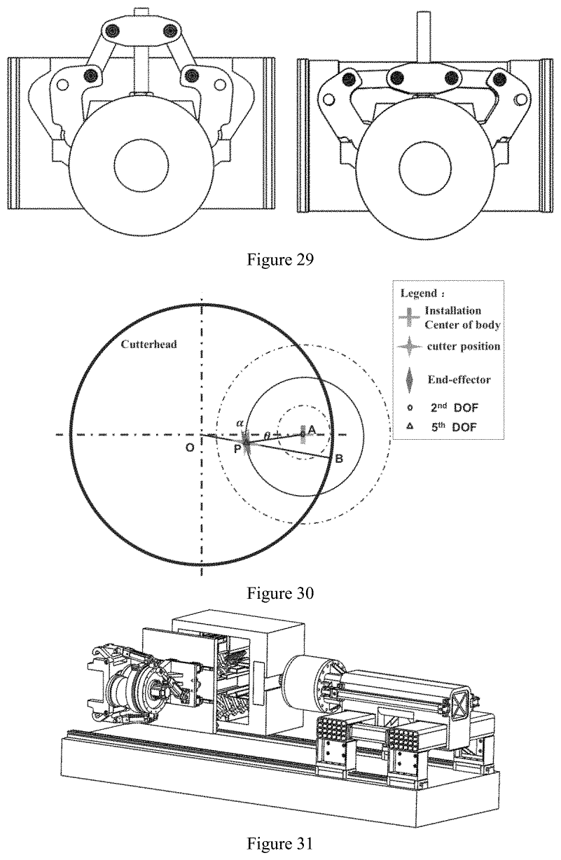

Working principle: the robot sends the integrated cutter system 18-2 into the cutter box 18-1 through the cutter gripper 20-10, at which time the four clamping blocks 20-1 are in the closed state; by rotating the screw 20-3; thus driving the four clamping blocks 20-1 to open, and the slot matched with clamping block 19-3 of the side panel of the cutter box 18-1 is clamped, as shown in FIG. 29.

III. Motion Analysis of Cutter Replacement Robot for the TBM

Aiming at the joint working space of the TBM cutter head from the horizontal narrow space to the vertical narrow space, the pole type TBM cutter replacement robot was designed, so that the working range of the cutter replacement robot can be adapted to the internal space of the TBM cutter head. The kinematics analysis is shown in FIG. 30.

FIG. 30 shows the back of the cutter head, i.e. the plane perpendicular to the axis of the body of the cutter replacement robot. The legend square cross mark represents the cutter replacement robot body mounting center, the star cross mark represents the cutter position, the diamond shape represents the end-effector pose, and the loop area formed by the dotted line is the working range of the cutter replacement robot.

Since the cutter cannot be accurately stopped in the horizontal position, taking the P point of the cutter stopped on the OB line as an example, the lift body 2-1 is deflected by θ degrees counterclockwise by the second degree of freedom of the robot; then moving the fourth and fifth joints of the robot, the third degree of freedom of the robot, make the axis of the end-effector (cutter center point) reach the P-point. The determination of the target position is completed by the above two steps.

The end-effector is adjusted by the fifth degree of freedom (angle adjustment device 5-3) of the cutter changer by rotating the end-effector clockwise by a degree.

The flexible end composed of the inner hexagonal sleeve 8-1 and the cross-shaft universal coupling 8-2 is to compensate for the error that the cross section A of the seat and the cross section B of the hand are not parallel. That is, the adjustment of the pitch and yaw angles of the end-effector is performed in a passive manner, thereby reducing the degree of freedom of the robot.

Step 1: When the TBM is tunneling, the initial state of the robot without cutter change is behind the cutter head pressure bin or main beam of the TBM as shown in FIG. 31. While the door of the robot cabin is closed, and the soil and rock slag in the cutter head will not touch the body of the robot. The joints were in the initial contraction state.

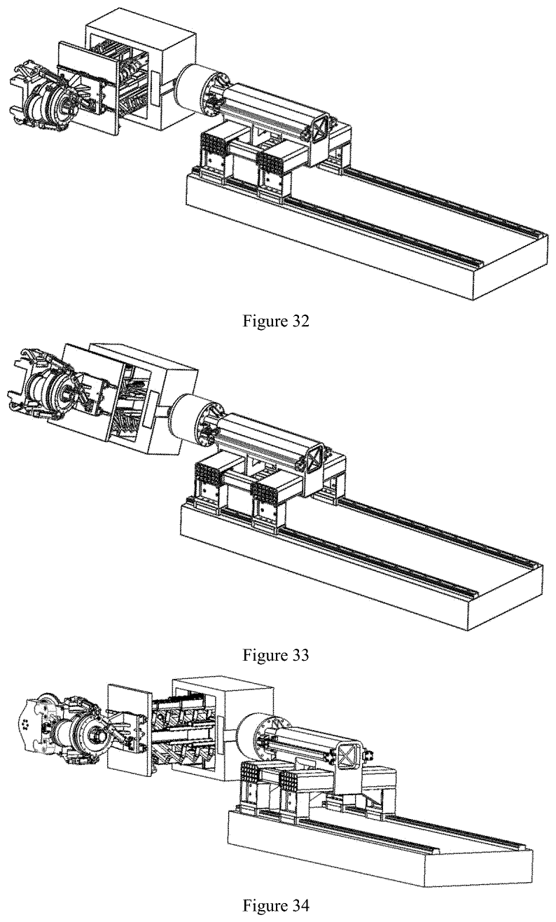

Step 2: When the TBM stops for maintenance, the cutter replacement begins. The robot slipper 4-6 and the telescopic arm of the robot 4-2 move forward. While the distance here is longer, the way of driving the ball screw by hydraulic motor can be chosen to drive the track seat to slide on the track. Then the third degree of freedom action of the cutter changer makes the end-effector move along the extreme path of the robot. The exit door of the cutter changing robot of the full-face TBM is shown in FIG. 32.

Step 3: The second, the third, the fourth and the fifth degrees of freedom of the robot are jointly moved to align the position and posture of the robot's end-effector with those of the three new types of cutters, and to adjust the attitude of the robot's end-effector. The end-effector is adjusted when the cutter changing robot changes the cutter as shown in FIG. 33.

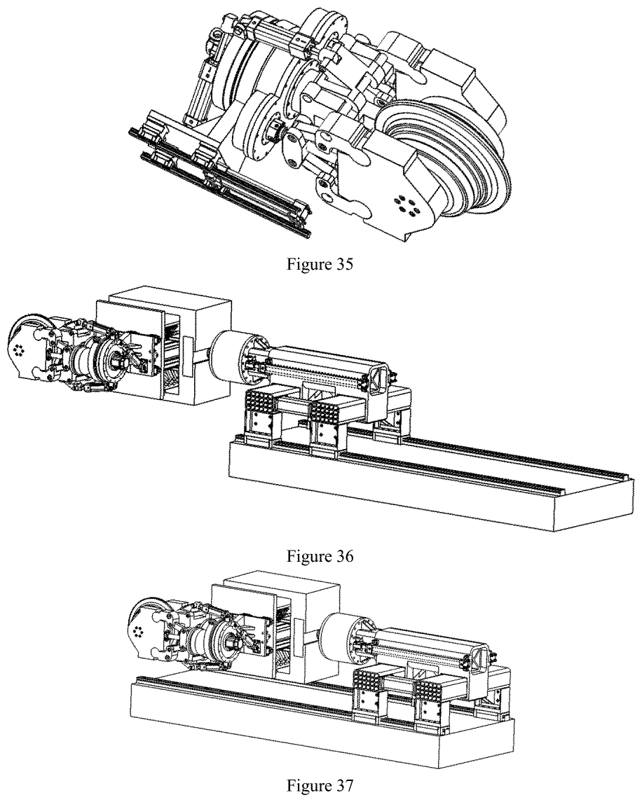

Step 4: The cutter grab device 5-2 and the screw bolts device 5-3 complete the loosening of the cutter and end-effector clamping the cutter. The sketch diagram of the cutter grasped by the robot is shown in FIG. 34, and the connection details of the end-effector and the cutter are shown in FIG. 35.

Step 5: The cutter-changing robot shrinks the elevator, adjusts the attitude of the end-effector, and prepares for the smooth launching of the warehouse door. The schematic diagram of the cutter-changing robot shrinks the joints of the TBM is shown in FIG. 36.

Step 6: The robot slipper 4-6 and the base arm of the robot 4-2 are moved backward to return to the initial state of the robot and complete the cutter disassembly action, as shown in FIG. 37.

Step 7: Install the cutter and disassemble the cutter in the opposite way.

We claim:

1. A cutter replacement robot and its adaptive cutter system for tunnel boring machine, wherein the cutter replacement robot and its adaptive cutter system for tunnel boring machine include a cutter change robot mechanism scheme, three types of new TBM cutter system and robot motion analysis;
I. cutter replacement robot mechanism
the cutter replacement robot is mainly composed of two parts: a body of the cutter replacement robot (1-1) and an end-effector of the cutter replacement robot (1-2); the body of the cutter replacement robot (1-1) is responsible for adjusting the position of the cutter center point and receiving the weight and the external load of the end-effector; the end-effector of the cutter replacement robot (1-2) is responsible for adjusting its posture and disassembling and assembling the cutter;
(1) body of the cutter replacement robot
the body of cutter replacement robot of TBM is mainly composed of main body of the scissor lift (2-1), guide rail (2-2), slide block of guide rail (2-3), big arm of the robot (2-4), sliding base of the robot (2-5) and fixed base of the robot (2-6); the fixed base of the robot (2-6) and the sliding base of the robot (2-5) constitute first mobile joint of the robot, and the big arm of the robot (2-4) and the sliding base of the robot (2-5) constitute second mobile joint of the robot, these two mobile joints constitute first degree of freedom of the cutter replacement robot; the slide block of guide rail (2-3) and the big arm of the robot (2-4) constitute third joint which is second degree of freedom of the cutter replacement robot; the guide rail (2-2) and the slide block of guide rail (2-3) constitute fourth joint of the robot; the main body of the scissor lift (2-1) and the guide rail (2-2) constitute fifth joint of the cutter replacement robot; the fourth joint and the fifth joint constitute third degree of freedom of the cutter replacement robot;
(2) end-effector of the cutter replacement robot
end-effector of the cutter replacement robot of TBM machine includes substrate of the end actuator (5-1), cutter grab device (5-2), screw bolts device (5-3), attitude adjustment device (5-4) and telescopic device (5-5);
the substrate of the end actuator (5-1) is mainly used for installation and connection, on which threaded holes are connected with linear guide rail (10-1) and telescopic hydraulic cylinder (10-2) through threads to provide the installation carrier for the end-effector;
the cutter grasping device (5-2) includes hydraulic cylinder for driving claw (6-1), connection joint between claw and hydraulic cylinder (6-2), claw movable part (6-3), claw fixing part (6-4) and connecting flange between claw and reducer (6-5); the hydraulic cylinder for driving claw (6-1) provides power for the claw movable part (6-3) tension; one end of the hydraulic cylinder for driving claw (6-1) is connected with reducer mounting plate (6-9) through hinging; the push rod of the hydraulic cylinder for driving claw (6-1) is connected with the connection joint between claw and hydraulic cylinder (6-2) through threads; the connection joint between claw and hydraulic cylinder (6-2) is connected with the claw movable part (6-3) through articulation; the claw movable part (6-3) and the claw fixing part (6-4) are connected by articulation; the claw fixing part (6-4) is connected with reducer housing cover (6-6) through the connecting flange between claw and reducer (6-5) to achieve the fixing of the cutter grab device (5-2);
the screw bolts device (5-3) comprises a reducer housing cover (6-6), a reducer housing (6-7), a reducer (6-8), a reducer mounting plate (6-9), a hydraulic motor (6-10), a reducer pinion (7-3), a large gear of the reducer (7-2), a reducer large gear installation plate (7-1), an inner hexagonal sleeve (8-1), cross-shaft universal coupling (8-2) and a transmission shaft (8-3); the hydraulic motor (6-10) provides power for screw, and is fixed with the reducer mounting plate (6-9) through threaded connection; the reducer (6-8) makes the power of the hydraulic motor (6-10) to reduce speed and increase torsion by connecting threads with the reducer mounting plate (6-9); the reducer large gear installation plate (7-1) connects the reducer (6-8) with the large gear of the reducer (7-2) through screw to realize motion transmission; the reducer housing (6-7) is fixed with the reducer (6-8) through screw, providing installation space for the reducer pinion (7-3), the large gear of the reducer (7-2) and the transmission shaft (8-3); the reducer housing cover (6-6) and the reducer housing (6-7) form a closed space through screw connection, which is convenient for gear protection and lubrication; the inner contour shape of the inner hexagonal sleeve (8-1) is hexagonal, and is connected with the transmission shaft (8-3) through the cross-shaft universal coupling (8-2); the cross-shaft universal coupling (8-2) realizes the pitch and deflection of the inner hexagonal sleeve (8-1); pitch and deflection of the inner hexagonal sleeve (8-1) are used to compensate position; the transmission shaft (8-3) is used to transfer motion through spline and the reducer pinion (7-3);
the attitude adjustment device (5-4) includes a steering hydraulic cylinder support hinge (9-1), an steering hydraulic cylinder (9-2) and a hydraulic cylinder joint (9-3); the steering hydraulic cylinder support hinge (9-1) is mounted on the base of reducer support (10-3) by screws to provide a mounting base for the steering hydraulic cylinder (9-2); the steering hydraulic cylinder (9-2) provides power for the adjustment action of the end-effector; the steering hydraulic cylinder (9-2) is articulated with the steering hydraulic cylinder support hinge (9-1), and push rod of the steering hydraulic cylinder (9-2) is connected to the hydraulic cylinder joint (9-3) through the thread; the hydraulic cylinder joint (9-3) is connected with the reducer mounting plate (6-9) through the pin shaft, and drives the cutter grab device (5-2) and the screw bolts device (5-3) to rotate the shaft to realize the fine tuning of the end-effector;
the telescopic device (5-5) comprises a linear guide rail (10-1), a telescopic hydraulic cylinder (10-2), a reducer support (10-3), a telescopic hydraulic cylinder outlet joint (10-4), a reducer support mounting seat (10-5) and a reducer support slipper (10-6), the linear guide rail (10-1) is fixed on the substrate of the end actuator (5-1) by screw; the reducer support slipper (10-6) is matched with the linear guide rail (10-1) to realize load-bearing and guidance; the telescopic hydraulic cylinder (10-2) provides power for the telescopic motion of end-effector;
the cylinder block of the telescopic hydraulic cylinder (10-2) is fixed on the substrate of the end actuator (5-1) by screw; the push rod of the telescopic hydraulic cylinder (10-2) is connected with the telescopic hydraulic cylinder outlet joint (10-4) through the thread; the bottom of reducer support (10-3) is connected with the reducer support slipper (10-6) through the reducer support mounting seat (10-5); the upper part of the reducer support (10-3) and the reducer housing (6-7) form a rotating pair; the telescopic hydraulic cylinder outlet joint (10-4) is fixed on the lower surface of the reducer support (10-3) by screw, which drives the reducer support (10-3) to move in a straight line and further drives the hob grab device (5-2), the screw bolts device (5-3) and the attitude adjustment device (5-4) moving in a straight line;
II. new TBM cutter systems
the new TBM cutter system scheme 1
the first integrated full-face rock TBM cutter holder is mainly composed of four components: cutter clamping mechanism (11-1), cutter box (11-2), cutter (11-3) and cutter gripper (11-4);
the cutter clamping mechanism (11-1) is mainly composed of screw (12-1), axle sleeve (12-2), shifting fork (12-3), clamping block (12-4), clamping block slider (12-5), cutter fixed frame (12-6), pin shaft (12-7), tapered roller bearing (12-8) and spin axis clamping block and shifting fork (12-9); the screw (12-1) has a stepped section; the screw (12-1) can be rotated around itself by two tapered roller bearings (12-8), and the screw (12-1) passes through the threaded hole of the shifting fork (12-3) to drive the shifting fork (12-3) to move up and down; the upper end of the screw (12-1) is axially positioned by the axle sleeve (12-2); the middle of the shifting fork (12-3) is machined with a vertical threaded hole, and the square cavity is machined on both sides; the square cavity of the shifting fork (12-3) matches with the clamping block (12-4) which are connected by two spin axis clamping block and shifting fork (12-9); the clamping block (12-4) is installed in the square groove of the cutter fixed frame (12-6) through the pin shaft (12-7); the clamping block slider (12-5) is fixed on the square groove of the cutter fixed frame (12-6) by four screws; the upper surface of the clamping block slider (12-5) is an arc groove, and the first clamping block (12-4) can slide along the arcuate groove of the clamping block slider (12-5); the cutter shaft of the cutter (11-3) is fixed between the two cutter fixed frame (12-6) by screws;
the cutter box (11-2) is mainly composed of two cutter box welding section (13-1) and two cutter box side panel (13-2); the cutter box welding section (13-1) reduces the processing difficulty of the cutter box side panel (13-2), and at the same time acts as the function of connection; the inside of the cutter box side panel (13-2) is provided with slot matched with clamping block (13-3) and a profile matching with cutter fixed frame (12-6); the contour of the slot matched with clamping block (13-3) is matched with the card edge profile of the first clamping block (12-4), so that the slot matched with clamping block (13-3) can be well positioned while receiving a large impact load from the cutter; the cutter box (11-2) is welded to the cutter head during the operation of the full-face tunnel boring machine;
the cutter gripper (11-4) is used to connect the two cutter fixed frames (12-6), and at the same time, the robot is convenient to take the cutter out of the cutter box;
III. motion analysis of cutter replacement robot for the TBM
aiming at the joint working space of the TBM cutter head from the horizontal narrow space to the vertical narrow space, the pole type TBM cutter replacement robot is designed, so that the working range of the cutter replacement robot can be adapted to the internal space of the TBM cutter head.

2. The cutter replacement robot and its adaptive cutter system for tunnel boring machine according to claim 1, wherein the main body of the scissor lift (2-1) includes movable board of lift (3-1), shear mechanism (3-2), upper ball screw (3-3), driving gear of the shearing mechanism (3-4), driven gear of the shearing mechanism (3-5), hydraulic motor (3-6), substrate of the scissor lift (3-7), central connection ring (3-8), bending plate (3-9) and lower ball screw (3-10); the hydraulic motor (3-6) is installed on the upper surface of the substrate of the scissor lift (3-7); the driving gear of the shearing mechanism (3-4) is directly fixed on the output shaft of the hydraulic motor (3-6); the driven gear of the shearing mechanism (3-5) is installed on the lower surface of the substrate of the scissor lift (3-7) and meshes with the driving gear of the shearing mechanism (3-4); one end of the upper ball screw (3-3) is fixed on the lower surface of the substrate of the scissor lift (3-7), and the other end is connected to the shaft hole of the driven gear of the shearing mechanism (3-5); the upper end rod of the shear mechanism (3-2) is connected with the nut sleeve of the upper ball screw (3-3); the lower end rod of the shearing mechanism (3-2) is connected with the nut sleeve of the lower ball screw (3-10); the lower ball screw (3-10) is installed on the upper surface of the movable board of lift (3-1); the four sets of bending plate (3-9) are composed of four bending plates in series; the upper end of bending plate (3-9) is connected to the lower surface of the substrate of the scissor lift (3-7), and the lower end is connected to the upper surface of the movable board of lift (3-1); the end-effector is fixed on the lower surface of the movable board of lift (3-1);
the big arm of the robot (2-4) includes a swing hydraulic motor (4-1), telescopic arm of the robot (4-2) and single-rod double-acting hydraulic cylinder (4-4); the swing hydraulic motor (4-1) is mounted on the telescopic arm of the robot (4-2), and its output shaft is matched with the central hole of slide block of guide rail (2-3); two single-rod double-acting hydraulic cylinders 4-4 are symmetrically mounted on the left and right sides of the base arm of robot (4-3);
the sliding base of the robot (2-5) includes the base arm of the robot (4-3), robot arm support leg (4-5) and robot slipper (4-6); the robot arm support leg (4-5) is mainly composed of two saddle-shaped structural steels connected by two hollow square bars; the robot slipper (4-6) is fixed at the bottom of the robot arm support leg (4-5) through bolts; the robot slipper (4-6) and the fixed base of the robot (2-6) cooperate to realize sliding; the base arm of the robot (4-3) is connected to the saddle-shaped structural steel of the robot arm support leg (4-5).

3. The cutter replacement robot and its adaptive cutter system for tunnel boring machine according to claim 1, wherein the new TBM cutter system scheme 2 replaces the new TBM cutter system scheme 1;
second type of TBM cutter system comprises the cutter box (14-1), cutter (14-2), the cutter fixed frame (14-3), the clamping device (14-4), a lifting and lifting and shifting device (14-5) and cutter gripper (14-6);
the inner surface of the cutter box (14-1) is adapted to the shape of the outer surface of the cutter fixed frame (14-3); the slot matched with clamping block (15-1) is formed inside the cutter box (14-1) to realize a fastening cutter;
the cutter fixed frame (14-3) is connected to the arbor of the cutter of scheme 2 (14-2) by screws and fixed to the clamping device (14-4) by screws;
the clamping device (14-4) includes a clamping block support plate (16-1), a clamping block rotating shaft (16-2), a protective plate (16-3), a dial block (16-4), and a clamping block (16-5); the clamping block support plate (16-1) is fixed to the upper part of the cutter fixed frame (14-3) by screws, and supports other parts; the clamping block (16-5) constitutes a rotating pair by the connection of the clamping block rotating shaft (16-2) and the clamping block (16-5); the two ends of the clamping block rotating shaft (16-2) are fixed to the clamping block support plate (16-1) by screws, and are used for fixing the clamping block (16-5) on the clamping block support plate (16-1); the dial block (16-4) is welded to the clamping block (16-5), and the clamping blocking movement of the clamping block (16-5) is achieved by dialing the dial block (16-4); the protective plate (16-3) is connected to the upper support frame of the cutter fixed frame (14-3) by screws to prevent dust and gravel from entering, and affects the opening movement of the clamping block (16-5);
the lifting and shifting device (14-5) comprises a guide rail (17-1), a slider of clamping block (17-2), a bearing seat (17-3), a screw (17-4), a nut mounting seat (17-5) and a rotating carrier (17-6); the guide rail (17-1) is a square frame structure, and a rail is arranged in the square frame; the guide rail (17-1) is connected to the upper support frame of the cutter fixed frame (14-3) by screws; the shape of the boss on the outer side of the two sides of the slider of clamping block (17-2) is adapted to the groove formed on the clamping block support plate (16-1) to realize a linear motion freedom; the inner side of the two sides of the slider of clamping block (17-2) is provided with a hole, and the bearing is mounted to realize the bearing function; the rotating carrier (17-6) is matched with the slider of clamping block (17-2); the nut mounting seat (17-5) is fixed to the upper surface of the guide rail (17-1) by screw connection; the screw (17-4) is matched with the nut mounting seat (17-5) through the thread pair, and the screw (17-4) thread can be self-locking; the screw (17-4) passes through the nut mounting seat (17-5), protrudes into the guide rail (17-1), and is fixed on the slider of clamping block (17-2) through the bearing seat (17-3); by rotating the screw (17-4), the reciprocating linear motion of the slider of clamping block (17-2) along the guide rail (17-1) is realized, and the rotating carrier (17-6) is further driven to rotate the shaft; thus, the dial block (16-4) is dialed to realize the opening movement of the clamping block (16-5);
the cutter gripper (14-6) is mounted on the clamping block support plate (16-1), the two ends are fixed by screws, and the end-effector realizes the cutter entering and leaving the cutter box (14-1) by grasping the cutter gripper (14-6).

4. The cutter replacement robot and its adaptive cutter system for tunnel boring machine according to claim 1, wherein the new TBM cutter system scheme 3 replaces the new TBM cutter system scheme 1;
the third full-face rock TBM cutter system is mainly composed of a cutter box (18-1), an integrated cutter system (18-2) and a cutter (18-3);
the cutter box (18-1) is a box mainly composed of two cutter box side panels (19-1) and two cutter box welding sections (19-2); the upper half of the left and right sides of the two cutter box side panels (19-1) are respectively provided with the slot matched with clamping blocks (19-3);
the integrated cutter system (18-2) is mainly composed of a clamping block (20-1), a connecting rod (20-2), a screw (20-3), a special nut (20-4), a pre-tightening nut (20-5), and an end cover (20-6), upper bearing bush (20-7), lower bearing bush (20-8), cutter mounting plate (20-9) and cutter gripper (20-10); the clamping block (20-1) has an open slot at the upper end thereof, and a through hole is formed in the direction of the vertical opening slot; a through hole for connecting the cutter gripper (20-10) is opened on one side of the clamping block (20-1), and the lower end of the clamping block (20-1) is stepped arc cylinder of which the stepped surface is used for positioning and rotates around the arcuate groove on the side panel (20-9) of the cutter; the connecting rod (20-2) is used to connect the clamping block (20-1) and the special nut (20-4), and the movement of the special nut (20-4) is converted into the rotation of the clamping block (20-1) while supporting the clamping block (20-1) to befitted on the slot matched with clamping block (19-3) of the cutter box; the special nut (20-4) is a nut-like structure with a threaded hole in the center and an open slot at both ends; the open slot of the upper end of the clamping block (20-1) and the open slot of the special nut (20-4) are used to realize the connection of the clamping block (20-1), the connecting rod (20-2) and the special nut (20-4); the screw (20-3) passes through the central threaded hole of the special nut (20-4), and further fixes the cutter mounting plate (20-9); the pre-tightening nut (20-5) is set on the screw (20-3), and is located on the upper surface of the cutter side panel (20-9), which moves up and down in synchronization with the special nut (20-4) as the screw (20-3) rotates; which act as a double nut lock; the upper end cap (20-6) is used to fix one end of the screw (20-3) so that it can only rotate around itself and cannot move up and down; the upper bearing bush (20-7) and the lower bearing bush (20-8) limit the diameter of the slide block of guide rail (2-3) move to the side while being easy to replace after wear; the lower contour surface of the cutter mounting plate (20-9) completely fits the side surface of the cutter box side panel (19-1), and functions similarly to the frame for fixing and connecting the accessory parts; the cutter gripper (20-10) is attached to the clamping block (20-1) to facilitate the robot to remove the integrated cutter system (18-2) from the cutter box (18-1); at the same time, the slide block of guide rail (2-3) of the new full-face tunneling machine integrated cutter system needs to be self-locking.
